(19) United States
(12) Patent Application Publication
(10) Pub. No.: US 2005/0141044 A1
(43) Pub. Date: Jun. 30, 2005

(54) Image processing apparatus, control method thereof, and program

(75) Inventor: Hiroyasu Morita, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/001,016

(22) Filed: Dec. 2, 2004

(30) Foreign Application Priority Data
Dec. 5, 2003 (JP) 2003-407773

(51) Int. Cl. H04N 1/40

(52) U.S. Cl. 358/448; 358/474

(57) ABSTRACT

A scanner unit sequentially reads original pages set in the paper feed mechanism. The read image is stored in a storage unit by adding the read image to a predetermined file. Reading unit information which represents the number of read original pages when the originals set in the paper feed mechanism are read is generated. After the end of reading of the original pages set in the paper feed mechanism, unless the reading end is instructed, every time original pages are set in the paper feed mechanism, reading by the scanner unit, storage in the storage unit, and generation of the reading unit information are executed. If the reading end is instructed, the read images in the predetermined file stored in the storage unit are split on the basis of the generated reading unit information. Each of the split read images is converted into a file having a designated file format. Each converted file is transmitted to the designated transmission destination.

### FIELD OF THE INVENTION

The present invention relates to an image processing apparatus which reads an original and transmits the obtained read image to a designated transmission destination, a control method thereof, and a program.

### BACKGROUND OF THE INVENTION

There exist image processing systems which cause a scanner to read an original or a reception function to receive an image and transmit the read or received image in a designated image file format to a designated destination.

An example of such image processing systems is a digital multifunction apparatus having a transmission/reception function. In this image processing system, to transmit an original image of a plurality of pages read by a scanner to a designated transmission destination, the image is converted into an appropriate image file format designated by the user and then transmitted. Detailed examples of the image file format are TIFF, JFIF, and PDF.

In this image processing system, if the selected image file format allows one file to contain a plurality of pages, whether to put all pages to be transmitted in one file or transmit one page as one file can be selected (e.g., Japanese Patent Laid-Open No. 2001-358857).

In the prior art, however, only one of the mode of putting all images to be transmitted in one file and the mode of transmitting each page as one file is designated.

Hence, the system cannot meet a requirement to transmit a plurality of original pages, which should be transmitted as different files, to a single transmission destination by one processing.

In this case, the user repeats an operation of transmitting the respective original pages in a desired split unit to the single transmission destination.

To implement this operation, the user may be caused to input the split unit in advance. However, this complicates the operation.

### SUMMARY OF THE INVENTION

The present invention has been made to solve the above-described problems, and has as its object to provide an image processing apparatus which can easily and efficiently transmitting the read images of a plurality of original pages in desired split unit to a designated transmission destination, a control method thereof, and a program.

According to the present invention, the foregoing object is attained by providing, an image processing apparatus which transmits a read image obtained by reading an original to a designated transmission destination, comprising:
a reading unit, having a paper feed mechanism, adapted to sequentially read original pages set in the paper feed mechanism;
a storage unit, adapted to store the read image read by the reading unit by adding the read image to a predetermined file;
a generation unit, adapted to generate reading unit information which represents the number of read originals when the original pages set in the paper feed mechanism of the reading unit are read;
an instruction unit, after an end of reading of the original pages set in the paper feed mechanism of the reading unit, adapted to instruct whether to cause the reading unit to execute reading of another original or end reading by the reading unit;
a control unit, unless an end of reading by the reading unit is instructed by the instruction unit, every time original pages are set in the paper feed mechanism of the reading unit, adapted to execute reading by the reading unit, storage by the storage unit, and generation by the generation unit;
a split unit, when the end of reading by the reading unit is instructed by the instruction unit, adapted to split read images in the predetermined file stored in the storage unit on the basis of the reading unit information generated by the generation unit;
a conversion unit, adapted to convert each of the read images split by the split unit into a file having a designated file format; and
a transmission unit, adapted to transmit each file converted by the conversion unit to the designated transmission destination.

In a preferred embodiment, the apparatus further comprises
a first designation unit, adapted to designate the file format, and a second designation unit, adapted to designate the transmission destination.

In a preferred embodiment, the transmission unit includes a plurality of kinds of data transmission units.

In a preferred embodiment, the apparatus further comprises operation unit, adapted to display an operation window, wherein the instruction unit is generated on the operation window of the operation unit.

According to the present invention, the foregoing object is attained by providing an image processing apparatus which transmits a read image obtained by reading an original to a designated transmission destination, comprising:
a reading unit, having a paper feed mechanism, adapted to sequentially read original pages set in the paper feed mechanism;
a storage unit, adapted to store the read image read by the reading unit as one file;
an instruction unit, after an end of reading of the original pages set in the paper feed mechanism of the reading unit, adapted to instruct whether to cause the reading unit to execute reading of another original or end reading by the reading unit;
a control unit, unless an end of reading by the reading unit is instructed by the instruction unit, every time original pages are set in the paper feed mechanism of the reading unit, adapted to execute reading by the reading unit and storage by the storage unit;
a conversion unit, when the end of reading by the reading unit is instructed by the instruction unit, adapted to convert each file stored in the storage unit into a file having a designated file format; and
a transmission unit, adapted to transmit each file converted by the conversion unit to the designated transmission destination.

In a preferred embodiment, the apparatus further comprises
a first designation unit, adapted to designate the file format, and a second designation unit, adapted to designate the transmission destination.

In a preferred embodiment, the transmission unit includes a plurality of kinds of data transmission units.

In a preferred embodiment, the appratus further comprises an operation unit, adapted to display an operation window,
wherein the instruction unit is generated on the operation window of the operation unit.

According to the present invention, the foregoing object is attained by providing a control method for an image processing apparatus which transmits a read image obtained in reading an original to a designated transmission destination, comprising:
a reading step of sequentially reading original pages set in a paper feed mechanism;
a storage step of storing the read image read in the reading step in a storage medium by adding the read image to a predetermined file;
a generation step of generating reading unit information which represents the number of read original pages when the originals set in the paper feed mechanism are read;
an instruction step of, after an end of reading of the original pages set in the paper feed mechanism in the reading step, instructing whether to read another original in the reading step or end reading in the reading step;
a control step of, unless an end of reading in the reading step is instructed in the instruction step, every time original pages are set in the paper feed mechanism, executing reading in the reading step, storage in the storage step, and generation in the generation step;
a split step of, when the end of reading in the reading step is instructed in the instruction step, splitting read images in the predetermined file stored in the storage medium on the basis of the reading unit information generated in the generation step;
a conversion step of converting each of the read images split in the split step into a file having a designated file format; and
a transmission step of transmitting each file converted in the conversion step to the designated transmission destination.

According to the present invention, the foregoing object is attained by providing a control method for an image processing apparatus which transmits a read image obtained in reading an original to a designated transmission destination, comprising:
a reading step of sequentially reading original pages set in a paper feed mechanism;
a storage step of storing the read image read in the reading step in a storage medium as one file;
an instruction step of, after an end of reading of the original pages set in the paper feed mechanism in the reading step, instructing whether to read another original in the reading step or end reading in the reading step;
a control step of, unless an end of reading in the reading step is instructed in the instruction step, every time original pages are set in the paper feed mechanism, executing reading in the reading step and storage in the storage step;
a conversion step of, when the end of reading in the reading step is instructed in the instruction step, converting each file stored in the storage medium into a file having a designated file format; and
a transmission step of transmitting each file converted in the conversion step to the designated transmission destination.

According to the present invention, the foregoing object is attained by providing a program which implements control of an image processing apparatus which transmits a read image obtained in reading an original to a designated transmission destination, comprising:
a program code for a reading step of sequentially reading original pages set in a paper feed mechanism;
a program code for a storage step of storing the read image read in the reading step in a storage medium by adding the read image to a predetermined file;
a program code for a generation step of generating reading unit information which represents the number of read original pages when the originals set in the paper feed mechanism are read;
a program code for an instruction step of, after an end of reading of the original pages set in the paper feed mechanism in the reading step, instructing whether to read another original in the reading step or end reading in the reading step;
a program code for a control step of, unless an end of reading in the reading step is instructed in the instruction step, every time original pages are set in the paper feed mechanism, executing reading in the reading step, storage in the storage step, and generation in the generation step;
a program code for a split step of, when the end of reading in the reading step is instructed in the instruction step, splitting read images in the predetermined file stored in the storage medium on the basis of the reading unit information generated in the generation step;
a program code for a conversion step of converting each of the read images split in the split step into a file having a designated file format; and
a program code for a transmission step of transmitting each file converted in the conversion step to the designated transmission destination.

According to the present invention, the foregoing object is attained by providing a program which implements control of an image processing apparatus which transmits a read image obtained in reading an original to a designated transmission destination, comprising:
a program code for a reading step of sequentially reading original pages set in a paper feed mechanism;
a program code for a storage step of storing the read image read in the reading step in a storage medium as one file;
a program code for an instruction step of, after an end of reading of the original pages set in the paper feed mechanism in the reading step, instructing whether to read another original in the reading step or end reading in the reading step;
a program code for a control step of, unless an end of reading in the reading step is instructed in the instruction step, every time original pages are set in the paper feed mechanism, executing reading in the reading step and storage in the storage step;
a program code for a conversion step of, when the end of reading in the reading step is instructed in the instruction step, converting each file stored in the storage medium into a file having a designated file format; and
a program code for a transmission step of transmitting each file converted in the conversion step to the designated transmission destination.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an image processing system according to the first embodiment of the present invention;

FIG. 2 is a flowchart showing processing executed by the image processing system according to the first embodiment of the present invention;

FIG. 3 is a view showing a setting example of split information according to the first embodiment of the present invention;

FIG. 4 is a flowchart showing details of processing in step S211 according to the first embodiment of the present invention;

FIG. 5 is a flowchart showing processing executed by an image processing system according to the second embodiment of the present invention;

FIG. 6 is a view for explaining the structure of a file created in the second embodiment of the present invention; and

FIG. 7 is a flowchart showing details of processing in step S409 according to the second embodiment of the present invention.

### DESCRIPTION OF THE PREFERRED EMBODIMENTS

Preferred embodiments of the present invention will be described in detail in accordance with the accompanying drawings.

### First Embodiment

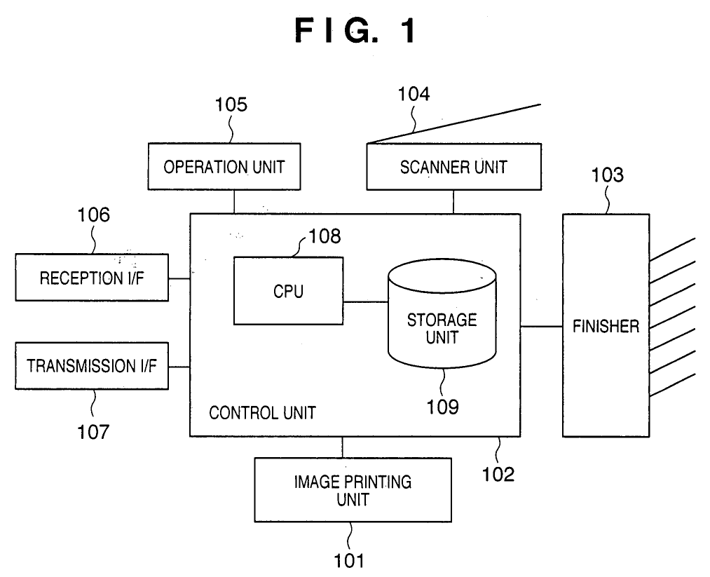

FIG. 1 is a block diagram showing the arrangement of an image processing system according to the first embodiment of the present invention.

In each embodiment of the present invention, a multifunction apparatus will be described as an image processing system. However, the present invention is not limited to this and can be applied to any other device (e.g., a personal computer having a data transmission/reception function and image reading function) having a similar function to the multifunction apparatus.

The multifunction apparatus shown in FIG. 1 includes an image printing unit 101, control unit 102 finisher 103, scanner unit 104 having a paper feed mechanism, operation unit 105, a plurality of reception interfaces (I/Fs) 106, and a plurality of transmission interfaces (I/Fs) 107. The respective units are connected to the control unit 102 through dedicated interfaces.

The image printing unit 101 can use, as its image printing function, various kinds of methods such as a laser beam method, inkjet method, and thermal transfer method. An image printed on a printing medium by the image printing unit 101 is output onto the finisher 103.

As the reception interfaces (I/Fs) 106 and transmission interfaces (I/Fs) 107, various kinds of communication interfaces such as a network interface, FAX interface, IEEE1394 interface, and USB interface can arbitrarily be combined.

Accordingly, the image processing system can execute data transmission/reception to/from external devices on the network connected through the reception interfaces (I/Fs) 106 and transmission interfaces (I/Fs) 107. Examples of the external devices are an image file server, its client machine, storage device, and another image processing system having the same function as that of the image processing system.

The network connected to the image processing system through the reception interface (I/F) 106 and transmission interface (I/F) 107 is typically the Internet, a LAN, WAN, telephone line, dedicated digital line, ATM, frame relay line, communication satellite channel, cable TV line, or data broadcast radio channel, or a so-called communication network implemented by a combination thereof. The network only needs to be able to transmit/receive data.

The main unit of the control unit 102 includes a central processing unit (CPU) 108 and a storage unit 109.

The operation unit 105 includes, e.g., a display unit and an input unit such as a ten-key pad and buttons so that various kinds of input operations to execute various kinds of processing in the image processing system can be performed. The operation unit 105 may include a touch panel which integrates the display unit and input unit.

The storage unit 109 includes a RAM which functions as a data work area or a temporary save area and a ROM which stores various kinds of control programs and parameters to control the image processing system as well as a hard disk drive and a DVD-RAM/RW drive as a mass storage device.

In the image processing system according to the first embodiment, an original to be processed is set on the scanner unit 104, or an image already stored in the storage unit 109 is designated from the operation unit 105. The transmission destination is designated from the operation unit 105, and transmission is instructed. The transmission program to transmit the image executes necessary image conversion for transmission.

Examples of the transmission form by the transmission program are FAX transmission, email transmission, and file transmission (FTP or HTTP).

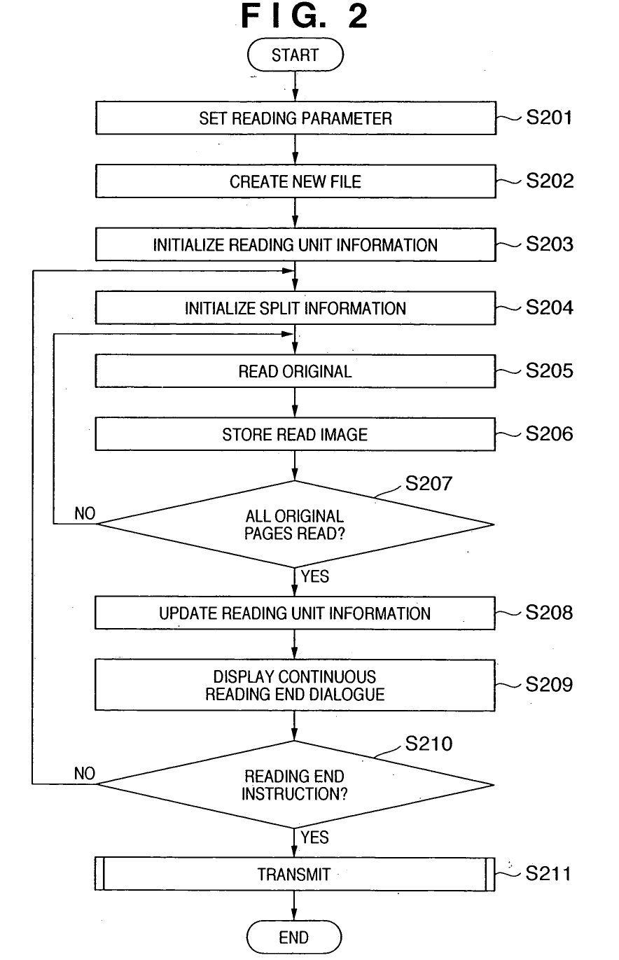

Processing (continuous reading processing) executed by the image processing system according to the first embodiment will be described next with reference to FIG. 2.

Note that the following processing is processing in which a continuous reading processing mode is set by the operation unit 105.

The continuous reading processing mode means that original pages are read while changing original pages to be read to generate plural set of original pages read of a sequence from an indication of start of reading to an indication of end of reading as one job (a file). For example, if an operation is performed for FTP (File Transfer Protocol) transmission, a file generated by the sequence is transmitted by FTP, if an operation is performed for email transmission, a file generated by the sequence is transmitted by email.

FIG. 2 is a flowchart showing processing executed by the image processing system according to the first embodiment of the present invention.

First, reading parameters for reading, which are set from the operation unit 105, are set in the scanner unit 104 (step S201).

Examples of the reading parameters are the reading resolution, color/monochrome reading, and reading size of the scanner unit 104 for reading.

Next, a new file is created in the storage unit 109 (step S202). The new file is used to generate a file which is to be formed by sequentially adding the read image of an original read from the scanner unit 104 in step S205.

Reading unit information to be set in the new file is initialized (step S203).

The reading unit information represents the total number of pages (reading unit) of original pages to be read by one continuous reading cycle when a plurality of original pages set in the scanner unit 104 are to be read (continuously read).

Split information to be set for each reading unit is initialized (step S204).

The split information represents the number of splits to split page images corresponding to each continuous reading unit (the total number of original pages) from one file which contains read images obtained by continuous reading and is stored in the storage unit 109 when reading (continuous reading) of the plurality of original pages set in a feeding mechanism (an auto document feeding mechanism) the scanner unit 104 is executed a plurality of number of times.

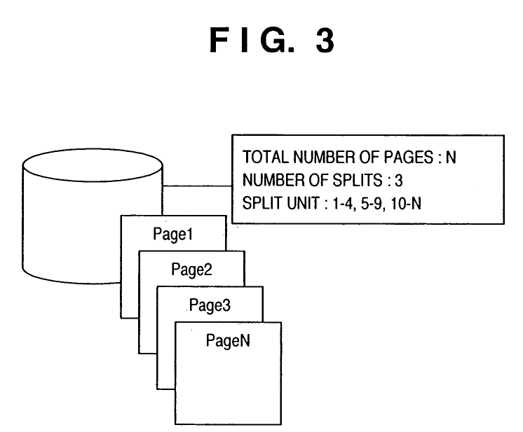

A detailed example of the split information will be described with reference to FIG. 3.

FIG. 3 shows split information and reading unit information which are obtained by, e.g., executing continuous reading of a plurality of original pages set in the scanner unit 104 three times. In this example, the reading unit information corresponding to each continuous reading is “4” for the first continuous reading, “5” for the second continuous reading, and “(N−10)+1” for the third continuous reading. The split information is “3”.

The description will be continued with reference to FIG. 2.

Subsequently, the scanner unit 104 executes reading of the originals set in the paper feed mechanism of the scanner unit 104 (step S205). Each read image is stored in the storage unit 109 by adding it to the new file generated in step S202 (step S206). At this time, the reading counter to count the number of read images is incremented by one.

The central processing unit 108 determines whether all the original pages set in the paper feed mechanism of the scanner unit 104 are read (step S207).

If not all the original pages are read (NO in step S207), the flow returns to step S205. On the other hand, if all the original pages are read (YES in step S207), the reading unit information to be set in the read image stored in the storage unit 109 is updated on the basis of the value indicated by the reading counter (step S208). In the example shown in FIG. 3, “4” is set first as the reading unit information, “5” is set by the next continuous reading, and “(N−10)+1” is set by the third continuous reading.

Next, a dialogue (continuous reading end dialogue) which inquires about whether to set a new original in the paper feed mechanism of the scanner unit 104 and read it or end the reading is displayed on the operation unit 105 (step S209). The central processing unit 108 determines whether the response from the continuous reading end dialogue is a reading end instruction (step S210).

If the response is no reading end instruction (NO in step S210), the flow returns to step S204. The user sets a new original in the paper feed mechanism of the scanner unit 104. The processing in steps S204 to S209 is executed. On the other hand, if the response is a reading end instruction (YES in step S210), split information corresponding to the number of pieces of reading unit information for the read images stored in the storage unit 109 is generated. On the basis of the split information and reading unit information, the read images stored in the storage unit 109 are split into a plurality of page image groups. Each page image group is converted into a designated image file format and then transmitted to a designated transmission destination (step S211). The processing is ended.

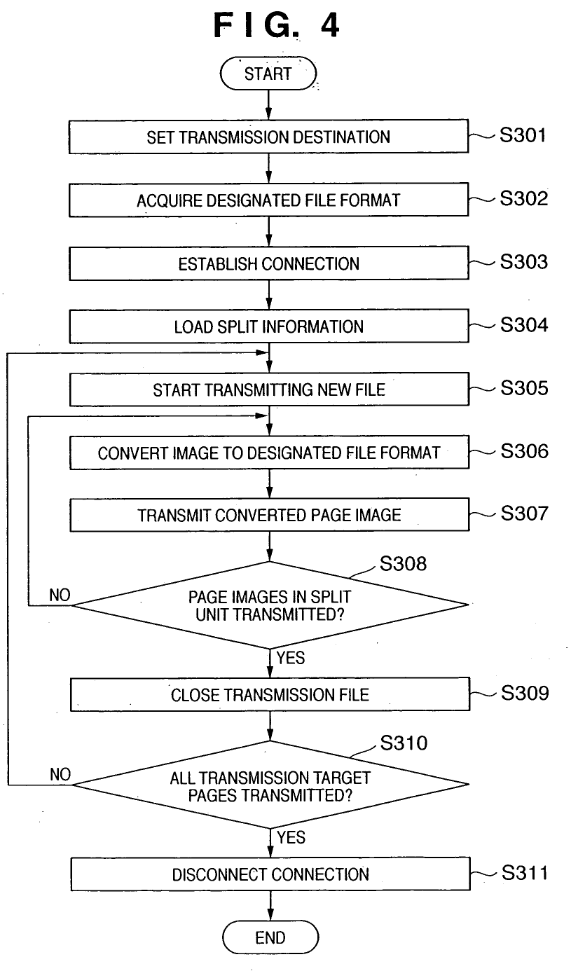

Details of the processing in step S211 in FIG. 2 will be described next with reference to FIG. 4.

FIG. 4 is a flowchart showing details of the processing in step S211 according to the first embodiment of the present invention.

First, the transmission destination of the read images stored in the storage unit 109 is set on the basis of input from the operation unit 105 (step S301). Similarly, the designated (image) file format to which the read images are to be converted at the time of transmission is acquired on the basis of input from the operation unit 105 (step S302).

Designation of the transmission destination and file format is implemented by, e.g., displaying a dedicated designation window on the operation unit 105.

Examples of the image file format are PDF, JFIF, and TIFF.

A communication connection to the transmission destination set in step S301 is established through the transmission interface 107 (step S303). The split information set for the read images to be transmitted, which are stored in the storage unit 109, is loaded (step S304).

A new file to transmit, as one file, a page image group corresponding to the first split unit (reading unit information) of the number of splits indicated by the split information to the transmission destination set in step S301 is generated (step S305). In the example shown in FIG. 3, “4” is acquired first as the split unit, “5” is acquired by the next processing, and “(N−10)+1” is acquired by the third processing.

The central processing unit 108 converts the page images in the read images to be transmitted into the file format designed in step S302 (step S306). The page image file converted into the designated file format is transmitted to the transmission destination set in step S301 by adding the file to the new file generated in step S305 (step S307).

After transmission of the page image file, the central processing unit 108 determines whether the number of transmitted page image files has reached the split unit (step S308). If the number has not reached the split unit yet (NO in step S308), the flow returns to step S306. If the number has reached the split unit (YES in step S308), the new file generated in step S305 is closed (step S309).

The central processing unit 108 determines whether all the page images to be transmitted in each split unit of the split information are transmitted (step S310). If not all the page images to be transmitted are transmitted (NO in step S310), the flow returns to step S305.

If all the page images to be transmitted are transmitted (YES in step S310), the communication connection established in step S303 is disconnected (step S311). The processing is ended.

As described above, according to the first embodiment, unless the reading end instruction is executed, every time a plurality of original pages are set in the paper feed mechanism of the scanner unit 104 and continuously read, the number of original pages read by each continuous reading is generated as reading unit information, and a series of read images obtained by each continuous reading are stored as one file in the storage unit.

The read image group in the file is split into a plurality of page image groups on the basis of the generated reading unit information so that a file corresponding to each page image group is generated and transmitted to the designated by, e.g. FTP etc., transmission destination.

Note that if transmission is performed with a protocol of email, after generating one file, the file is converted into email form to transmit the file as one attached file of email.

With this arrangement, each read image group obtained by continuous reading can be transmitted to the designated transmission destination as one file by executing the operation for transmission only once.

### Second Embodiment

In the first embodiment, reading unit information for a read image obtained by each continuous reading is generated. The reading unit information is referred to as a split unit so that a series of read images obtained by each continuous reading are split into page images in each spilt unit intended by the user and transmitted. However, the present invention is not limited to this. The same effect as described above can also be obtained even by, e.g., appropriately generating a file containing read images obtained by continuous reading every time continuous reading is executed and transmitting each of the plurality of files.

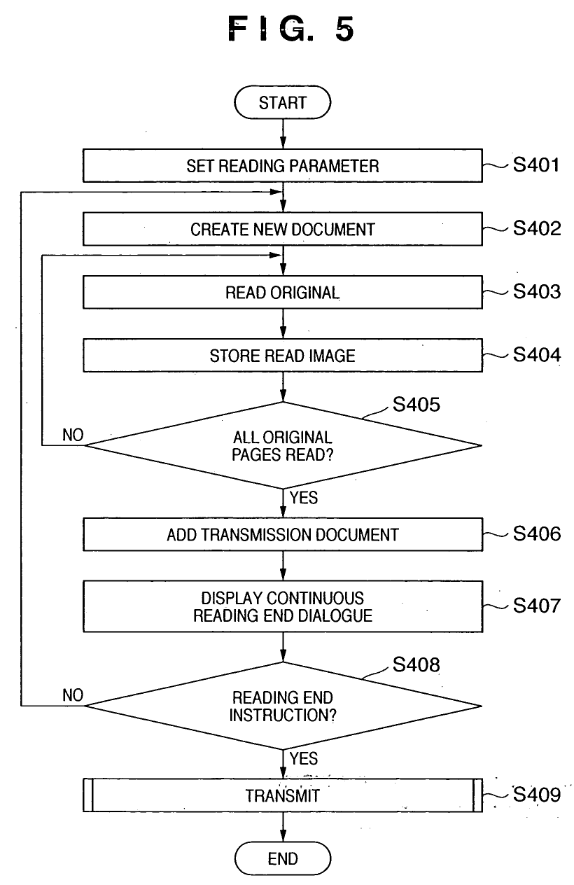

Processing (continuous reading processing) executed by an image processing system according to the second embodiment will be described below with reference to FIG. 5.

FIG. 5 is a flowchart showing processing executed by the image processing system according to the second embodiment of the present invention.

First, reading parameters for reading, which are set from an operation unit 105, are set in a scanner unit 104 (step S401). A new file is created in a storage unit 109 (step S402).

Subsequently, the scanner unit 104 executes reading of the original pages set in the paper feed mechanism of the scanner unit 104 (step S403). Each read image is stored in the storage unit 109 by adding it to the new file generated in step S402 (step S404).

A central processing unit 108 determines whether all the original pages set in the paper feed mechanism of the scanner unit 104 are read (step S405).

If not all the original pages are read (NO in step S405), the flow returns to step S403. On the other hand, if all the original pages are read (YES in step S405), the read image group stored in the storage unit 109 by adding it to the new file is added as a file to be transmitted (step S406).

Next, a dialogue (continuous reading end dialogue) which inquires about whether to set a new original in the paper feed mechanism of the scanner unit 104 and read it or end the reading is displayed on the operation unit 105 (step S407). The central processing unit 108 determines whether the response from the continuous reading end dialogue is a reading end instruction (step S408).

If the response is no reading end instruction (NO in step S408), the flow returns to step S402 to create a new file to add the read image of the new original.

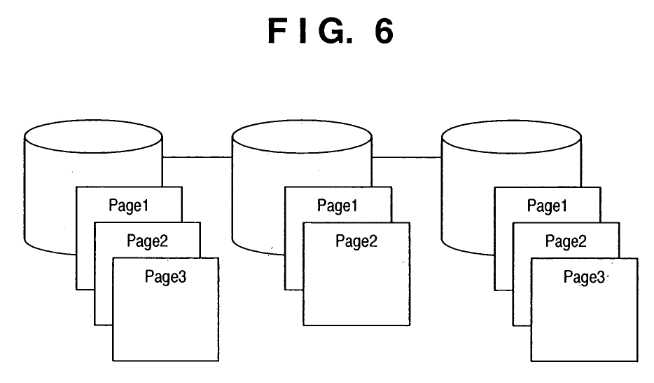

When the processing in step S402 to S408 is repeated, a plurality of files as shown in FIG. 6 are stored in the storage unit 109.

On the other hand, if the response is a reading end instruction (YES in step S408), each of the files to be transmitted, which are stored in the storage unit 109, is converted into a designated image file format and transmitted to the designated transmission destination (step S409). The processing is ended.

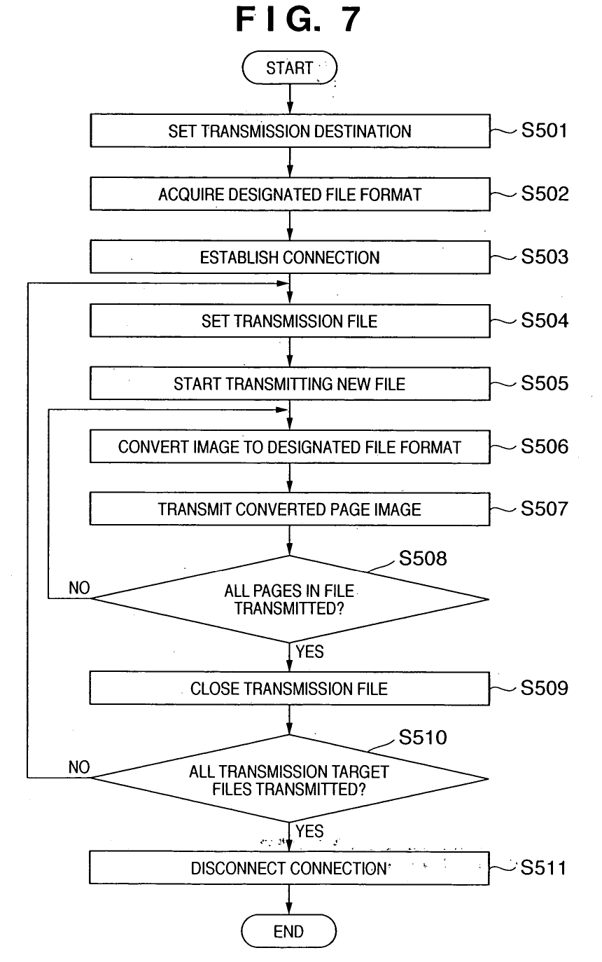

Details of the processing in step S409 in FIG. 5 will be described next with reference to FIG. 7.

FIG. 7 is a flowchart showing details of the processing in step S409 according to the second embodiment of the present invention.

First, the transmission destination of a file stored in the storage unit 109 is set on the basis of input from the operation unit 105 (step S501). Similarly, the designated (image) file format to which the file is to be converted at the time of transmission is acquired on the basis of input from the operation unit 105 (step S502).

A communication connection to the transmission destination set in step S501 is established through a transmission interface 107 (step S503). A file to be transmitted is set from the file group stored in the storage unit 109 (step S504).

A new file to transmit, as one file, the files to be transmitted to the transmission destination set in step S501 is generated (step S505).

The central processing unit 108 converts the page images in the file to be transmitted into the file format designed in step S502 (step S506). The page image file converted into the designated file format is transmitted to the transmission destination set in step S501 by adding the file to the new file generated in step S505 (step S507).

After transmission of the page image file, the central processing unit 108 determines whether all the page images in the file to be transmitted are transmitted in step S504 (step S508). If not all the page images are transmitted (NO in step S508), the flow returns to step S506. If all the page images are transmitted, the new file generated in step S505 is closed (step S509).

Next, the central processing unit 108 determines whether all the files to be transmitted are transmitted (step S510). If not all the files to be transmitted are transmitted (NO in step S510), the flow returns to step S504 to set a file to be transmitted for the file group stored in the storage unit 109. The processing in steps S505 to S510 is executed.

If all the files to be transmitted are transmitted (YES in step S510), the communication connection established in step S503 is disconnected (step S511). The processing is ended.

As described above, according to the second embodiment, unless the reading end instruction is executed, every time a plurality of originals are set in the paper feed mechanism of the scanner unit 104, a file containing a read image group obtained by continuous reading of the originals is generated, and the plurality of generated files are transmitted to a designated transmission destination.

With this arrangement, each read image group obtained by continuous reading can be transmitted to the designated transmission destination as one file by executing the operation for transmission only once.

Therefore, in case of the above example as shown in FIG. 6, three files generated from each original pages set in a feeding unit of the scanner unit 104 can be transmitted to the designated by FTP etc. transmission destination as one file. Furthermore, if email transmission, the three files are converted into one email form file to transmit the email form file as an attached file.

Note that a file format of each of file to be split can be also designated to different file format.

The embodiments have been described above. The present invention can also take a mode such as a system, apparatus, method, program, or storage medium. More specifically, the present invention can be applied to either a system including a plurality of devices or an apparatus including a single device.

The present invention is also achieved even by supplying a software program (in the embodiments, a program corresponding to the illustrated flowcharts) which implements the functions of the above-described embodiments to the system or apparatus directly or from a remote site and causing the computer of the system or apparatus to read out and execute the supplied program code.

Hence, to implement the functional processing of the present invention by a computer, the program code itself, which is installed in the computer, also implements the present invention. That is, a computer program itself, which implements the functional processing of the present invention, is also incorporated in the present invention.

In this case, the program can take any form such as an object code, a program to be executed by an interpreter, or script data to be supplied to the OS as long as the functions of the program can be obtained.

As a recording medium for supplying the program, for example, a floppy (registered trademark) disk, hard disk, optical disk, magnetooptical disk, MO, CD-ROM, CD-R, CD-RW, magnetic tape, nonvolatile memory card, ROM, or DVD (DVD-ROM or DVD-R) can be used.

As another program supply method, a client computer may be connected to a homepage on the Internet using a browser in the computer, and the computer program itself of the present invention or a compressed file containing an automatic install function may be downloaded from the homepage to a recording medium such as a hard disk. A program code that constitutes the program of the present invention may be divided into a plurality of files, and the files may be downloaded from different homepages. That is, a WWW server which causes a plurality of users to download a program file that causes a computer to implement the functional processing of the present invention is also incorporated in the present invention.

The program of the present invention may be encrypted, stored in a storage medium such as a CD-ROM, and distributed to users. Any user who satisfies predetermined conditions may be allowed to download key information for decryption from a homepage through the Internet, execute the encrypted program using the key information, and install the program in the computer.

The functions of the above-described embodiments are implemented not only when the readout program is executed by the computer but also when the OS or the like, which is running on the computer, performs part or all of actual processing on the basis of the instructions of the program.

The functions of the above-described embodiments are also implemented when the program read out from the storage medium is written in the memory of a function expansion board inserted into the computer or a function expansion unit connected to the computer, and the CPU of the function expansion board or function expansion unit performs part or all of actual processing on the basis of the instructions of the program.

The present invention is not limited to the above embodiments and various changes and modifications can be made within the spirit and scope of the present invention. Therefore, to apprise the public of the scope of the present invention, the following claims are made.

### CLAIM OF PRIORITY

This application claims priority from Japanese Patent Application No. 2003-407773 filed on Dec. 5, 2003, the entire contents of which are hereby incorporated by reference herein.

1. An image processing apparatus which transmits a read image obtained by reading an original to a designated transmission destination, comprising:
a reading unit, having a paper feed mechanism, adapted to sequentially read original pages set in the paper feed mechanism;
a storage unit, adapted to store the read image read by said reading unit by adding the read image to a predetermined file;
a generation unit, adapted to generate reading unit information which represents the number of read originals when the original pages set in the paper feed mechanism of said reading unit are read;
an instruction unit, after an end of reading of the original pages set in the paper feed mechanism of said reading unit, adapted to instruct whether to cause said reading unit to execute reading of another original or end reading by said reading unit;
a control unit, unless an end of reading by said reading unit is instructed by said instruction unit, every time original pages are set in the paper feed mechanism of said reading unit, adapted to execute reading by said reading unit, storage by said storage unit, and generation by said generation unit;
a split unit, when the end of reading by said reading unit is instructed by said instruction unit, adapted to split read images in the predetermined file stored in said storage unit on the basis of the reading unit information generated by said generation unit;
a conversion unit, adapted to convert each of the read images split by said split unit into a file having a designated file format; and
a transmission unit, adapted to transmit each file converted by said conversion unit to the designated transmission destination.

2. The apparatus according to claim 1, further comprising
a first designation unit, adapted to designate the file format, and a second designation unit, adapted to designate the transmission destination.

3. The apparatus according to claim 1, wherein said transmission unit includes a plurality of kinds of data transmission units.

4. The apparatus according to claim 1, further comprising operation unit, adapted to display an operation window,
wherein said instruction unit is generated on the operation window of said operation unit.

5. An image processing apparatus which transmits a read image obtained by reading an original to a designated transmission destination, comprising:
a reading unit, having a paper feed mechanism, adapted to sequentially read original pages set in the paper feed mechanism;
a storage unit, adapted to store the read image read by said reading unit as one file;
an instruction unit, after an end of reading of the original pages set in the paper feed mechanism of said reading unit, adapted to instruct whether to cause said reading unit to execute reading of another original or end reading by said reading unit;
a control unit, unless an end of reading by said reading unit is instructed by said instruction unit, every time original pages are set in the paper feed mechanism of said reading unit, adapted to execute reading by said reading unit and storage by said storage unit;
a conversion unit, when the end of reading by said reading unit is instructed by said instruction unit, adapted to convert each file stored in said storage unit into a file having a designated file format; and
a transmission unit, adapted to transmit each file converted by said conversion unit to the designated transmission destination.

6. The apparatus according to claim 5, further comprising
a first designation unit, adapted to designate the file format, and
a second designation unit, adapted to designate the transmission destination.

7. The apparatus according to claim 5, wherein said transmission unit includes a plurality of kinds of data transmission units.

8. The apparatus according to claim 5, further comprising an operation unit, adapted to display an operation window,
wherein said instruction unit is generated on the operation window of said operation unit.

9. A control method for an image processing apparatus which transmits a read image obtained in reading an original to a designated transmission destination, comprising:
a reading step of sequentially reading original pages set in a paper feed mechanism;
a storage step of storing the read image read in the reading step in a storage medium by adding the read image to a predetermined file;
a generation step of generating reading unit information which represents the number of read original pages when the originals set in the paper feed mechanism are read;
an instruction step of, after an end of reading of the original pages set in the paper feed mechanism in the reading step, instructing whether to read another original in the reading step or end reading in the reading step;
a control step of, unless an end of reading in the reading step is instructed in the instruction step, every time original pages are set in the paper feed mechanism, executing reading in the reading step, storage in the storage step, and generation in the generation step;
a split step of, when the end of reading in the reading step is instructed in the instruction step, splitting read images in the predetermined file stored in the storage medium on the basis of the reading unit information generated in the generation step;
a conversion step of converting each of the read images split in the split step into a file having a designated file format; and
a transmission step of transmitting each file converted in the conversion step to the designated transmission destination.

10. A control method for an image processing apparatus which transmits a read image obtained in reading an original to a designated transmission destination, comprising:
a reading step of sequentially reading original pages set in a paper feed mechanism;
a storage step of storing the read image read in the reading step in a storage medium as one file;
an instruction step of, after an end of reading of the original pages set in the paper feed mechanism in the reading step, instructing whether to read another original in the reading step or end reading in the reading step;
a control step of, unless an end of reading in the reading step is instructed in the instruction step, every time original pages are set in the paper feed mechanism, executing reading in the reading step and storage in the storage step;
a conversion step of, when the end of reading in the reading step is instructed in the instruction step, converting each file stored in the storage medium into a file having a designated file format; and
a transmission step of transmitting each file converted in the conversion step to the designated transmission destination.

11. A program which implements control of an image processing apparatus which transmits a read image obtained in reading an original to a designated transmission destination, comprising:
a program code for a reading step of sequentially reading original pages set in a paper feed mechanism;
a program code for a storage step of storing the read image read in the reading step in a storage medium by adding the read image to a predetermined file;
a program code for a generation step of generating reading unit information which represents the number of read original pages when the originals set in the paper feed mechanism are read;
a program code for an instruction step of, after an end of reading of the original pages set in the paper feed mechanism in the reading step, instructing whether to read another original in the reading step or end reading in the reading step;
a program code for a control step of, unless an end of reading in the reading step is instructed in the instruction step, every time original pages are set in the paper feed mechanism, executing reading in the reading step, storage in the storage step, and generation in the generation step;
a program code for a split step of, when the end of reading in the reading step is instructed in the instruction step, splitting read images in the predetermined file stored in the storage medium on the basis of the reading unit information generated in the generation step;
a program code for a conversion step of converting each of the read images split in the split step into a file having a designated file format; and
a program code for a transmission step of transmitting each file converted in the conversion step to the designated transmission destination.

12. A program which implements control of an image processing apparatus which transmits a read image obtained in reading an original to a designated transmission destination, comprising:
a program code for a reading step of sequentially reading original pages set in a paper feed mechanism;
a program code for a storage step of storing the read image read in the reading step in a storage medium as one file;
a program code for an instruction step of, after an end of reading of the original pages set in the paper feed mechanism in the reading step, instructing whether to read another original in the reading step or end reading in the reading step;
a program code for a control step of, unless an end of reading in the reading step is instructed in the instruction step, every time original pages are set in the paper feed mechanism, executing reading in the reading step and storage in the storage step;
a program code for a conversion step of, when the end of reading in the reading step is instructed in the instruction step, converting each file stored in the storage medium into a file having a designated file format; and
a program code for a transmission step of transmitting each file converted in the conversion step to the designated transmission destination.
